(19) United States
(12) Patent Application Publication
(10) Pub. No.: US 2017/0353094 A1
(43) Pub. Date: Dec. 7, 2017

(54) GENERATOR SYSTEM FOR ENERGY CONSERVATION

(71) Applicant: James Sutliff, Sioux City, IA (US)

(72) Inventor: James Sutliff, Sioux City, IA (US)

(21) Appl. No.: 15/175,139

(22) Filed: Jun. 7, 2016

(51) Int. Cl. H02K 47/20; H02K 53/00

(52) U.S. Cl. CPC H02K 47/20; H02K 53/00; Y10S 74/09

(57) ABSTRACT

A system for power conservation in a residential building that includes: a motor; a generator, where the generator is powered by the motor; a power inverter, where the power inverter receives current from the generator; and a circuit breaker for the residential building, where the circuit breaker receives power from the power inverter based on pre-selected conditions. The motor is preferably a 110-volt motor, where the generator generates a current of about 350 amps to 450 amps directed to the power inverter. The power inverter generates 4000 to 500 watts of power. The system further includes an electric meter connected to the circuit breaker, where the power inverter transmits power to the circuit breaker for distribution in the residential building during peak power consumption periods and transmits power to the circuit breaker for distribution to the power grid during low power consumption periods.

### BACKGROUND OF THE INVENTION

### Field of Invention

The present invention relates to a system for energy conservation.

### Description of Related Art

Power consumption is an issue that is a great concern of modern society. In particular, most individuals receive residential power from a local power company and as a result there is a constant need for electrical power throughout a power grid. This constant power consumption has the result of burning resources and energy on a regular basis. These resources are of course costly and are limited in nature. As a result, it is very important to develop methods and systems that may reduce power consumption in a typical residence.

### SUMMARY OF THE INVENTION

The present invention relates to a system for power conservation in a residential building that includes: a motor; a generator, where the generator is powered by the motor; a power inverter, where the power inverter receives current from the generator; and a circuit breaker for the residential building, where the circuit breaker receives power from the power inverter based on pre-selected conditions. The motor is preferably a 110-volt motor, where the generator generates a current of about 350 amps to 450 amps directed to the power inverter. The power inverter generates 4000 to 500 watts of power. The system further includes an electric meter connected to the circuit breaker, where the power inverter transmits power to the circuit breaker for distribution in the residential building during peak power consumption periods and transmits power to the circuit breaker for distribution to the power grid during low power consumption periods.

### BRIEF DESCRIPTION OF DRAWINGS

FIG. 1 depicts a schematic of a power saving system in accordance with the present invention.

### DETAILED DESCRIPTION

The present invention relates to a system that is implemented within a residential building to assist in the reduction of power consumption. The present invention includes a power source in the form of a motor, which runs a generator that in turn taps into the power system for a residential building. Ideally, this small generator produces power in a range of 4000 to 5000 watts and may be implemented during peak power consumption hours. The system is implemented through a 110-volt motor preferably that turns a 350 to 450 amp generator that in turn powers a 4000 to 5000 watt power inverter. This inverter is connected into the circuit breaker of the household and ties into the electrical meter of the household. During low consumption, the generator sends power to the electrical grid or back to the local power supply. As a result, consumers reduce their electrical bill by implementing the system due to the reduction in dependence on the power grid. The system ideally generates 32,000 to 40,000 kilowatts per year of power.

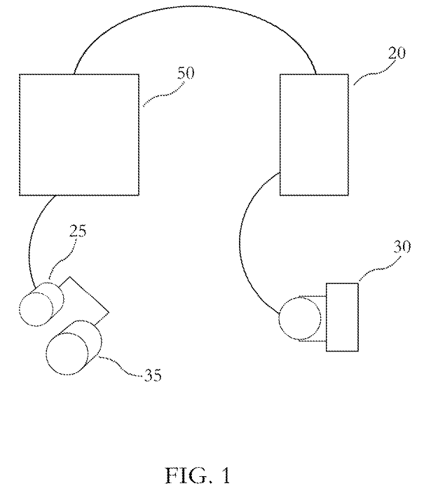

In reference to FIG. 1, a graphical implementation of the present system is depicted. The system includes a motor 35 connected to a generator 25. The motor preferably is a 110-volt motor that uses about 200 to 250 watts to turn the 350 to 450 amp generator 25. The generator 25 powers a power inverter 50 shown in FIG. 1. The power inverter 50 ties into the power grid through the house circuit breaker 20, as stated during high power consumption. The generator 25 helps to reduce dependency on the power grid by supplying additional power into the residence through the circuit breaker 20. Power consumption may be monitored through the electrical meter 30 as show in FIG. 1. As a result, this additional power insertion reduces dependency on the power grid and also ideally transfers power back to the power grid during low consumption times. The instant invention has been shown and described in what it considers to be the most practical and preferred embodiments. It is recognized, however, that departures may be made there from within the scope of the invention and that obvious modifications will occur to a person skilled in the art.

What is claimed is:

1. A system for power conservation in a residential building comprising:
a. a motor;
b. a generator, where the generator is powered by the motor;
c. a power inverter, where the power inverter receives current from the generator; and
d. a circuit breaker for the residential building, where the circuit breaker receives power from the power inverter based on pre-selected conditions.

2. The system according to claim 1, where the motor is a 110-volt motor.

3. The system according to claim 1, where the generator generates a current of about 350 amps to 450 amps directed to the power inverter.

4. The system according to claim 1, where the power inverter generates 4000 to 500 watts of power.

5. The system according to claim 1, further including an electric meter connected to the circuit breaker.

6. The system according to claim 1, where the power inverter transmits power to the circuit breaker for distribution in the residential building during peak power consumption periods.

7. The system according to claim 1, where the power inverter transmits power to the circuit breaker for distribution to the power grid during low power consumption periods.
